(19) United States
(12) Patent Application Publication
(10) Pub. No.: US 2004/0031252 A1
(43) Pub. Date: Feb. 19, 2004

(54) Filter element for filtering liquids from a stream of gas

(75) Inventor: Wolfgang Heikamp, Waldsee (DE)

Correspondence Address: CROWELL & MORING LLP, INTELLECTUAL PROPERTY GROUP, P.O. BOX 14300, WASHINGTON, DC, 20044-4300, US

(73) Assignee: Mann & Hummel GmbH, Ludwigsburg (DE)

(21) Appl. No.: 10/448,319

(22) Filed: May 30, 2003

(30) Foreign Application Priority Data
May 31, 2002 (DE) 102 24 224.0

(51) Int. Cl. B01D 46/00

(52) U.S. Cl. 55/486; 55/527; 55/498

(57) ABSTRACT

A filter element, especially for separating liquids from a gas stream, with a nonwoven filter web that is made of glass fibers and is arranged on a support body. The nonwoven filter web has a carbon fiber component of 5-30%, especially about 10%. Preferably the glass fibers are oleophobic and the carbon fibers are oleophilic.

### BACKGROUND OF THE INVENTION

The invention relates to a filter element, particularly for separating a liquid from a gas stream.

Published European Patent Application No. EP 674,582 describes such a filter element, which is made of a nonwoven filter web with metal fibers sintered together under pressure and a metal wire mesh as a support structure for the nonwoven filter web. The sintering process causes the metal fibers, which are at least 8 μm thick, to bake together, resulting in a comparatively low porosity of a maximum of 40%. This porosity is sufficient to filter untreated particle-laden air or other gaseous media, as the gas is able to flow through the gaps in the nonwoven filter web while avoiding an impermissibly high impact pressure. The cleaning of liquid media is not possible, however, or possible only to a limited degree. The relatively high density of the nonwoven filter medium only allows the liquid to flow through at a relatively high impact pressure, which cannot normally be produced or can damage the nonwoven filter medium.

Published European Patent Application No. EP 639,398 also describes a nonwoven filter web made of metal fibers, in which the metal fibers are supposed to have a diameter of 5 to 40 μm. The filter element is preferred for cleaning diesel exhausts; the nonwoven metal filter separates the soot particles from the exhaust. Due to its relatively high density, this nonwoven filter web, likewise, has only limited usefulness in the cleaning of contaminated liquids.

It is also known to use glass fibers instead of the nonwoven metal filter web. Glass fibers are essentially used to remove oil from air, i.e., to separate a liquid from a gas. Published German Patent Application No. DE 2,902,347 describes a filter element and a process for its production, in which a quantity of fibers is distributed in a liquid to form a slurry. The resulting dispersion is applied to a filter surface, so that the fibers collect thereon as a fiber mat and are retained by the filter surface. Suitable fibers include, for example, borosilicate microfibers or other fibers that can be produced by means of the described dispersion process. Filter systems produced in this way are suitable for various applications.

Such systems can be used, for instance, in the production of compressed air to remove oil from compressed air provided by a compressor. It has been shown that when a nonwoven glass fiber web is used, the residual oil content in the compressed air is initially very low but continues to increase after prolonged operation. Even the use of oleophobic glass fibers does not produce the desired result, i.e., a consistently low residual oil content.

### SUMMARY OF THE INVENTION

The object of the invention is to provide an improved filter element for separating a liquid from a gas stream.

Another object of the invention is to provide a filter element which can effectively separate entrained oil from a gas stream over a long period of time.

A further object of the invention is to provide a filter element for separating a liquid from a gas stream which has a long service life.

These and other objects are achieved in accordance with the present invention by providing a filter element for separating a liquid from a gas stream, comprising a nonwoven filter web made with glass fibers, wherein said nonwoven filter web has a carbon fiber content of 5-30%, preferably about 10%.

Further advantageous embodiments are described in detail hereinafter.

An important advantage of the invention is that the carbon fibers contained in the nonwoven glass fiber web optimize the residual oil content over a relatively long service life, i.e., they support the action of the oleophobic glass fibers. The advantage of the oleophobic glass fibers is that they have a low pressure loss because the medium can be made more open than usual. By means of the carbon fiber content and the improved action, it is possible to effectively separate oil from air using a filter with a smaller filter area.

One embodiment of the invention provides that the filter element be constructed from several layers. To this end, pure glass fiber layers may be combined with glass fiber/carbon fiber layers or glass fiber layers with pure carbon fiber layers. The filter element is advantageously arranged on a support body, having, for instance, a grate or lattice structure. This support body can have the shape of a hollow cylinder, so that the nonwoven filter web is wound onto the outer surface of the support body. It is also possible to arrange the non-woven filter web on the inner surface of the support body.

A further advantage of the carbon fibers is that electrostatic charges are avoided. Charging currents can be dissipated to the outside via the carbon fibers.

A further embodiment of the invention provides that the entire filter element be arranged in a replaceable box, similar to replaceable oil filter cartridges. The use of highly effective separation media makes it necessary to replace the elements after a certain number of service hours. It is important that no connections have to be detached and no additional clearance is required to remove the filter. This is solved by arranging the separation element in a box. The necessary pressure control units can be integrated in a connection head.

These and other features of preferred embodiments of the invention, in addition to being set forth in the claims, are also disclosed in the specification and/or the drawings, and the individual features each may be implemented in embodiments of the invention either alone or in the form of subcombinations of two or more features and can be applied to other fields of use and may constitute advantageous, separately protectable constructions for which protection is also claimed.

### BRIEF DESCRIPTION OF THE DRAWINGS

The invention will be described in further detail hereinafter with reference to illustrative preferred embodiments shown in the accompanying drawings in which:

FIG. 1 is a cross-section of a hollow cylindrical filter element with an interior support body and a composite of three superimposed layers of a nonwoven filter web disposed on the outer surface of the support body;

FIG. 2 is a separator for crankcase ventilation with an inserted filter element;

FIG. 3 is a cross-section of a separator element in a cartridge, and

FIG. 4 is a cross-section of a device for separating oil from air.

### DETAILED DESCRIPTION OF PREFERRED EMBODIMENTS

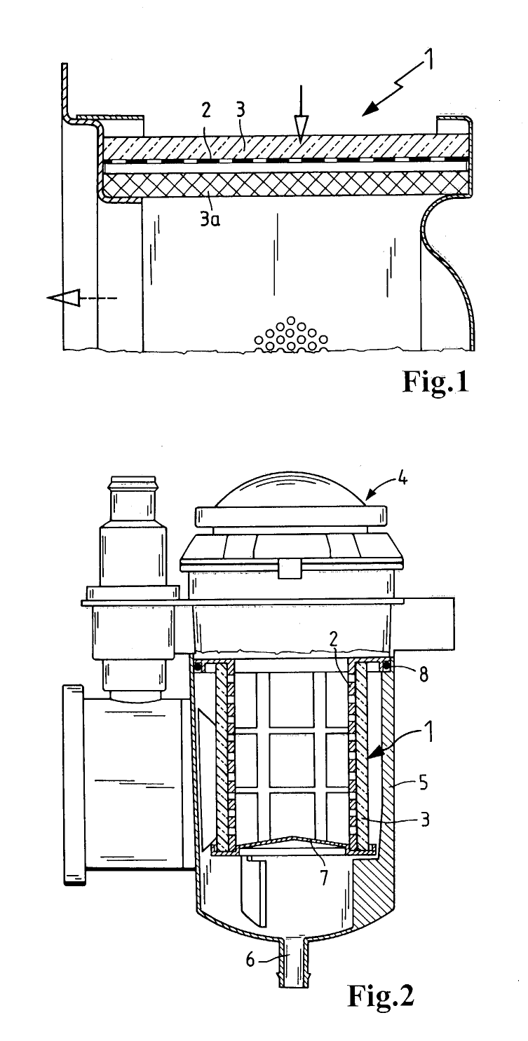

The filter element 1 depicted in FIG. 1 comprises a support body 2 having the shape of a hollow cylinder and one or more layers of a nonwoven filter web or fleece 3, which are wound around the cylindrical outer surface of the support body 2. Each layer of nonwoven filter web is made of glass fibers, forming an unsintered composite and thus having a high porosity of at least 90%, possibly even greater than 99%. Carbon fibers are advantageously arranged within each layer of the nonwoven filter web. The secondary nonwoven separator web 3a is made of a polyester material.

In a multilayer embodiment with at least two nonwoven filter web layers, the separating efficiency can be influenced by the fibers used in each of the layers. A further means for adjustment is the force with which the nonwoven filter web is wound around the support body. Due to the compressibility of the nonwoven filter web, the winding force affects the density of the nonwoven web and thus also the separation efficiency.

The support body is made of plastic or metal and comprises two end disks and a support tube for the nonwoven layer 3. The medium to be filtered, especially an oil/air mixture, flows preferably radially through the filter element 1, from the exterior to the interior, whereby the oil particles are separated and the air flows into the interior of the cylinder from where it is discharged in axial direction.

In some cases it may also be advantageous to have the medium flow through the filter element in the opposite direction, i.e., radially from the interior to the exterior, so that the unfiltered side is in the interior of the cylinder and the filtered side is radially on the exterior of the filter element. On the outlet side a drainage layer may be provided to facilitate discharge of the separated oil.

FIG. 2 shows a separator 4, used, in particular, for crankcase ventilation of an internal combustion engine or for removing oil from the air in compressors. A filter element 1 with a support body 2 and at least one nonwoven filter web 3 is used inside a housing 5 of the separator 4. The medium flows through the filter element 1 radially from the exterior to the interior. The unfiltered side lying radially on the exterior communicates with a discharge opening 6 in the floor of the housing 5 of the separator 4 through which the separated oil can be discharged from the separator. The filtered air is guided axially through the filtered side within the interior toward the top. On the bottom of the filter element 1, a bottom plate 7 connected with the support body 2 separates the filtered side from the unfiltered side below it. A sealing ring 8, which is seated in a locating groove in a lid section of the support body 2, provides a flow-tight seal toward the top between the interior of the filter element and the unfiltered side.

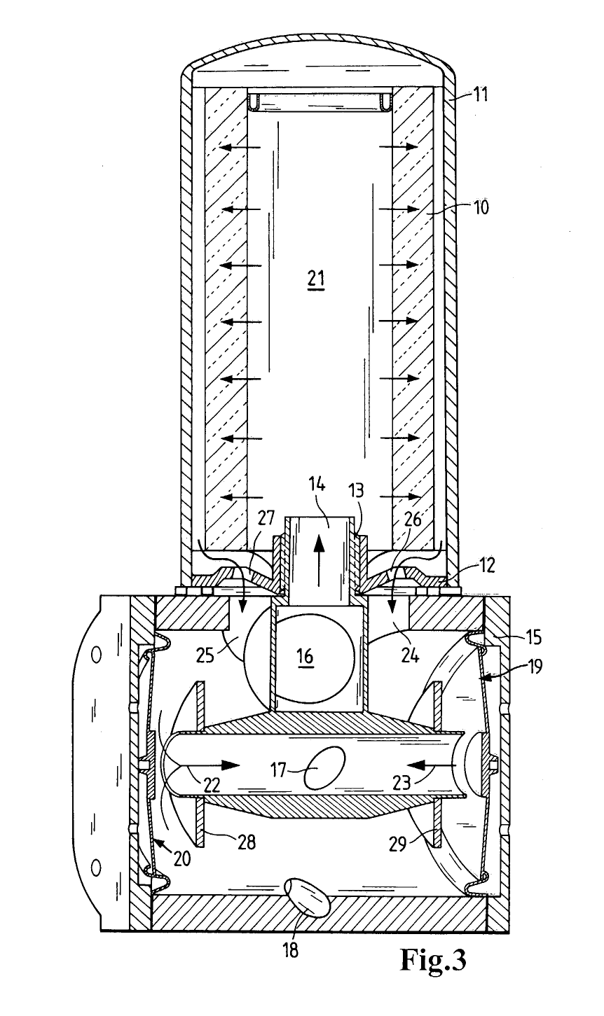

FIG. 3 shows a separator element inside a cartridge, which is constructed as an exchangeable element. The oil separator element 10 is disposed in a cup-shaped housing 11. At the bottom, this cup-shaped housing 11 is sealed by a lid 12. The housing 11 is connected with the lid 12 by a flanged edge. This lid 12 has a threaded bushing 13. By means of this threaded bushing 13, the entire separator element is screwed onto a threaded flange 14. The threaded flange 14 is part of a module support 15. This module support 15 has three connections: an inlet opening 16, an outlet opening 17, and a discharge opening 18. In addition, two vacuum valves 19, 20 are arranged in the module support 15.

The oil-laden air flows through the inlet opening 16 into the inlet chamber 21. From the inlet chamber 21, the air flows in the direction indicated by the arrows through the oil separator element 10, which contains the nonwoven filter web shown in FIG. 2. The oil-free air exits from the housing 11 of the exchangeable element through the openings 26, 27. The housing 11 is sealingly connected with the module support 15. As a result, the oil-free air exiting from the housing through the openings 26, 27 enters the module support 15 through the openings 24, 25. As indicated by the ar rows 22, 23, the oil-free air is guided toward the outlet opening 17.

The oil that collects in the oil separator element 10 and the oilfree air reaches the module support 15 through the openings 26, 27 or 24, 25. Here, the oil collects on the bottom and flows away through the discharge opening 18. Disks 28, 29 prevent the oil reaching the module support 15 through the openings 24, 25 from being entrained with the oilfree air stream to the outlet opening 17. These disks 28, 29 retain the oil and allow it to flow away in the direction of the discharge opening 18.

To replace the oil separator element 10, the element merely needs to be detached from the threaded flange 14. This has the advantage that no connections or other valves have to be detached or replaced. Furthermore, no additional clearance is required to remove the element.

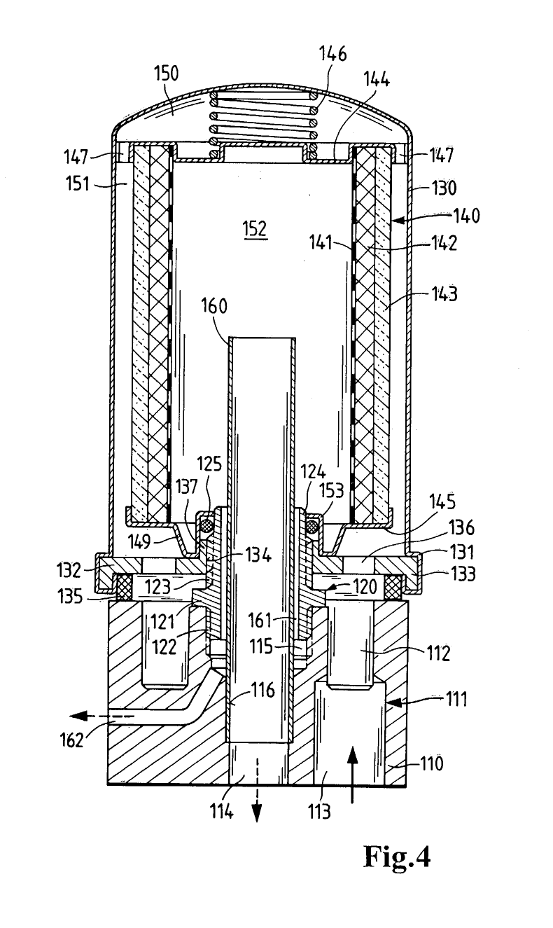

FIG. 4 is a cross-section of a device for separating oil from air. A separator head 110 for the unfiltered air is provided with an inlet channel 111, which is arranged off center and which has an annular channel 112 and a connection channel 113 discharging into this annular channel. For the filtered air, the separator head 110 has an outlet channel 114 arranged in the center, which in its upper region expands to a larger diameter where it is configured as a threaded bore 115.

A threaded pipe socket 120, in a central region, is provided with a collar 121 adjoined on both sides by threaded shoulders 122 and 123. By means of the lower threaded shoulder 122, the threaded pipe socket 120 is screwed into the threaded bore 115 of the separator head 110 until collar 121 makes contact.

A dome-shaped housing 130 is arranged along a vertical axis and is provided with a shoulder 131 near its lower end. A housing lid 132 is provided with an edge 133 bent in downward direction, which the housing 130 encompasses to form a seal when the housing lid 132 rests against the shoulder 131. The housing lid 132, which thus seals the housing at the lower end face, has a central threaded bore 134 in an annular collar 137, so that it can be screwed onto the threaded shoulder 123 of the threaded pipe socket 120 and, concentrically thereto, has a sealing ring 135 arranged radially outside therefrom and bonded thereto for a sealing abutment against the adjacent end face of the separator head 110. In the region between the threaded bore 134 and the sealing ring 135, the housing lid 132 has a plurality of inlet openings 136 arranged in a ring.

Inside the housing 130, a separator element 140 is arranged, which comprises a cylindrical perforated support shell 141, a separator ring 142 made of a nonwoven polyester material, a separator ring 143 as well as end disks 144 and 145 at the end faces. The separator ring is made of a glass fiber wrap with a carbon fiber component. This can of course also be a pleated (i.e., zigzag-shaped) glass fiber mat that also contains carbon fibers. The upper end disk 144 seals the separator element 140 at the upper end face and forms an abutment for a helical compression spring 146 that is supported against the bottom of the housing 130. Along the outer circumference, the upper end disk 144 has a plurality of radially outwardly projecting tabs 147 which serve to center the end disk 144, and consequently the separator element 140, within the housing 130 at the upper end.

The lower end disk 145 seals the lower end of the separator element 140. This lower end disk, and thus the separator element 140, are centered by an annular bead 149 along the annular collar 137 of the housing lid 132. The separator element 140 is axially pressed against the housing lid 132 by the helical compression spring 146 and partitions the interior 150 of the housing 130 into an unfiltered space 151 that communicates with the inlet openings 136 and a filtered space 152 that is connected to the threaded pipe socket 120.

To discharge the filtered air, the separator head 110 is provided with a standpipe 160, which is pressed into a snug seat 116 and opens into the outlet channel 114 and clearly protrudes over the threaded pipe socket 120 toward the top, extending to approximately the middle of the separator element 140. The standpipe 160 and the threaded pipe socket 120 form an annular gap 161 that is connected to a discharge channel 162.

The threaded pipe socket 120 has a cylindrical shoulder 124 in the region of its upper end. A sealing ring 125 is clamped radially between a cylinder wall 153 of the lower end disk 145 and the shoulder 124 of the threaded pipe socket 120 and thus hermetically seals the filtered air space 152 from the unfiltered air space 151.

During operation, the unfiltered air flows in the direction of the arrow through the connection channel 113, the annular channel 112 and the inlet openings 136 into the unfiltered air space 151. The air then successively crosses the separator rings 143 and 142 in which the fine oil droplets agglomerate into larger oil drops that settle toward the bottom. The filtered air leaves the separator element 140 through the standpipe 160 and the outlet channel 114. The oil settling on the lower end disk 145 and along the outer circumference of the standpipe 160 flows through the annular gap 161, the threaded bore 115 and the discharge channel 162 to the collecting basin (not shown).

The housing 130 with the separator element 140 is replaced whenever necessary, e.g., due to dirt accumulation, by simply unscrewing it from the threaded pipe socket 120 and screwing on a new housing 130 until the sealing ring 135 fits against the separator head 110 to form a seal. This creates all the connections required to guide the air to be filtered to the separator element 140, to draw off the filtered air and to discharge the oil to be separated.

The foregoing description and examples have been set forth merely to illustrate the invention and are not intended to be limiting. Since modifications of the described embodiments incorporating the spirit and substance of the invention may occur to persons skilled in the art, the invention should be construed broadly to include all variations within the scope of the appended claims and equivalents thereof.

What is claimed is:

1. A filter element for separating a liquid from a gas stream, comprising a nonwoven filter web made with glass fibers, wherein said nonwoven filter web has a carbon fiber content of 5-30%.

2. A filter element according to claim 1, wherein said nonwoven filter web has a carbon fiber content of about 10%.

3. A filter element according to claim 1, wherein the glass fibers are oleophobic glass fibers, and the carbon fibers are oleophilic fibers.

4. A filter element according to claim 1, wherein the carbon fibers are disposed between glass fiber layers in a multi-layer structure.

5. A filter element according to claim 1, wherein a support body is provided for the nonwoven filter web, and said support body has a lattice structure.

6. A filter element according to claim 1, wherein the nonwoven filter web is arranged on a support body.

7. A filter element according to claim 6, wherein the support body has the shape of a hollow cylinder, and the nonwoven filter web is wound around the outer circumference of the support body.

8. A filter element according to claim 6, wherein the filter element on said support body is mounted concentrically in a cup-shaped housing via a connecting plate, said housing having an inlet for an unfiltered gas stream and an outlet for a filtered gas stream, and said filter element being disposed between said inlet and said outlet.

9. A filter element according to claim 8, further comprising a drainage layer arranged on the outlet side of the nonwoven web.

10. A filter element according to claim 1, wherein the carbon fibers are electrically conductive and dissipate any electrostatic charges to the support body or to a discharge element.

11. A filter element according to claim 1, wherein the gas stream flows through the filter element radially outwardly from the interior toward the exterior.
